(19) United States
(12) Patent Application Publication
(10) Pub. No.: US 2017/0238573 A1
(43) Pub. Date: Aug. 24, 2017

(54) METHOD FOR PREPARING MILK-DERIVED PRODUCTS BASED ON CREAM, RICOTTA AND MIXTURES THEREOF INTENDED FOR QUICK- FREEZING OR FREEZING, PRODUCTS OBTAINED WITH SAID METHOD AND USES THEREOF

(71) Applicants: MOFIN S.R.L., 28100 NOVARA (NO) (IT); CASEIFICIO PUGLIESE F.LLI RADICCI S.P.A., 10020 LAURIANO (TO) (IT)

(72) Inventors: GIOVANNI MOGNA, NOVARA (IT); GIAN PAOLO STROZZI, MODENA (IT); SIMONA RADICCI, TORINO (IT)

(21) Appl. No.: 15/503,917

(22) PCT Filed: Aug. 18, 2015
(86) PCT No.: PCT/IB2015/056276

§ 371 Date: Feb. 14, 2017

(30) Foreign Application Priority Data
Aug. 18, 2014 (IT) MI2014A001500

(51) Int. Cl. A23C 19/068; A23C 13/08; A23L 33/21; A23C 19/05; A23C 19/076; A23C 21/08; A23C 19/097; A23C 13/12

(52) U.S. Cl. CPC A23C 19/0684; A23C 19/0976; A23C 13/085; A23C 13/12; A23C 19/054; A23C 19/0765; A23C 21/08; A23L 33/21; A23V 2002/00

(57) ABSTRACT

The present invention relates to a method which allows to quick-freezing or freezing, and subsequently thawing, without inducing any damage or modification, milk derivatives particularly sensitive to such thermal treatments, due to their distinct ive chemical-physical characteristics. The present method is useful for preparing cream, ricotta, and mixtures thereof, as well as foods containing the same, which can be stored while keeping their characteristics intact. Finally, the present invention further relates to cream, ricotta, and mixtures thereof, as well as foods containing the same thus obtained, capable to retain the organoleptic and chemical-physical characteristics of the fresh product. Thus, the present invention concerns a method for preparing milk-derived products preferably based on cream, ricotta or mixtures thereof intended for quick-freezing or freezing in order to retaining the organoleptic and chemical-physical characteristics of the fresh product.

The present invention relates to a method which allows to quick-freezing or freezing, and subsequently thawing, without inducing any damage or modification, milk derivatives particularly sensitive to such thermal treatments, due to their distinctive chemical-physical characteristics. The present method is useful for preparing cream, ricotta and mixtures thereof, as well as foods containing the same, which can be stored while keeping their characteristics intact. Finally, the present invention further relates to cream, ricotta and mixtures thereof, as well as foods containing the same thus obtained, having an extended shelf life, on equal organoleptic and chemical-physical characteristics. Therefore, the present invention concerns a method for preparing milk-derived products preferably based on cream, ricotta or mixtures thereof intended for quick-freezing or freezing in order to extend their shelf life.

Among the dairy products, by way of non-limiting example, the cream, the burrata, the sour cream, the smetana and other fermented products are mentioned, whereas among the culinary products, by way of example, creams, doughs, fillings, desserts, uncooked confectionery, sauces, first and second courses can be cited. Finally, the ricotta as whey-derived product is also mentioned.

In the current state of the art all the above-cited dairy and culinary products, such as those based on cream, ricotta and mixtures thereof, are considered unsuitable for their quick-freezing/freezing due to significant and irreversible changes in the chemical-physical and structural characteristics occurring during the thermal treatment of quick-freezing/freezing. The same applies for foods containing cream, such as, for example, the burrata, or the ricotta, or mixtures thereof.

For example the cream, which is known to be a fat-in-water emulsion, and all the foods containing the same as ingredient, such as for example the burrata, after quick-freezing or freezing and subsequent thawing, exhibit a clear separation of the two phases composing the emulsion. The aqueous phase based on buttermilk, containing nitrogen substances, lactose and mineral salts, separates from the lipid counterpart merged in granular aggregates, of yellow color due to the surface migration of carotenes. Basically, it was observed that during the quick-freezing/freezing step the fat-water emulsion undergoes deep and irreversible changes, which cause the disappearance of the emulsion itself, with the separation of the two phases. The same phenomenon also occurs in the ricotta and mixtures of cream and ricotta, as well as in all the foods containing the same. After thawing, the structural characteristics of the cream are, also visually, dramatically different from those of the cream not subjected to quick-freezing/freezing.

The irreversible changes which occur in the cream, following to the quick-freezing/freezing, were also found to take place in the ricotta or mixtures thereof, as well as in foods containing the same.

The fresh cream, which is a homogeneous and milky liquid, is appreciated and successfully used because of its property to soften and cream various ingredients having different characteristics. However, if the fresh cream itself is subjected to quick-freezing/freezing, and subsequently thawed, it turns to a non-homogeneous mass consisting of a semitransparent serous liquid, and yellow and lumpy fat aggregates. This physical modification leads to a cream unsuitable for alimentary uses, in which is successfully used as fresh, both as food and ingredient for preparing other foodstuffs, such as burrate.

Although a biochemical transformation has not occurred, the cream, once quickly-frozen or frozen and, subsequently, thawed, loses its property to amalgamate and cream the foodstuffs in which is used as fresh, and it also worsens from the palatability point of view, with an annoying graininess during the tasting. The same drawbacks also occur, for example, with the ricotta or burrata. Accordingly, thus far, a milk-derived product, such as for example the cream, or a whey-derived product, such as for example the ricotta, or a dairy product, such as for example the burrata, cannot be subjected, once prepared, to quick-freezing/freezing and subsequent thawing.

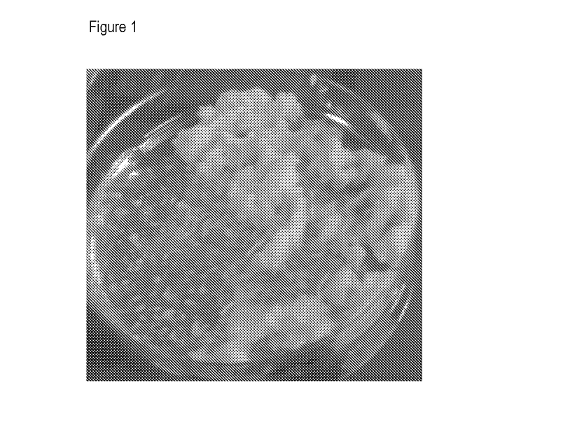

The picture of FIG. 1 shows the effect of quick-freezing/freezing and subsequent thawing of fresh cream with 28% of fat matter. In FIG. 1, on the right, granular aggregates of yellow color due to the surface migration of carotenes are seen, while on the left, the separation of the liquid buttermilk can be observed. It was found that the cream, after thawing, gives rise to a more marked separation of the liquid (buttermilk) than ricotta, whereas leads to a lesser amount of granule or lump aggregate relative to the ricotta.

Furthermore, it was found that the above-cited phenomenon occurs in all the commercially available kinds of cream, regardless of the modes being used for separating the fat from milk, the kind of the thermal treatment and the fat concentration. The same also applies, for example, for the ricotta or foodstuffs, such as the burrata.

Therefore, in order to extend the shelf life of the various commercially available kinds of cream, with different fat matter % and thermal treatment, it would be desirable to quick-freeze/freeze it, provided that, after thawing, the above-cited negative phenomena are absent. Accordingly, it is useful and convenient to have a method, which enables the quick-freezing/freezing of cream, ricotta and mixtures thereof, as well as foods containing the same, without impairing the organoleptic properties, the palatability and the typical qualities of a freshly made product.

Therefore, it would be desirable to quick-freeze/freeze and, subsequently, thaw the cream, the ricotta or mixtures thereof, as well as foods containing the same such as burrata, provided that, following to their thawing, the same aforementioned negative phenomena and drawbacks are absent.

In that case, we would be able to produce said milk- or whey-derived products, or foods containing the same in the place of origin and to deliver them in different places or foreign countries, without impairing the organoleptic properties, the palatability and the typical qualities of freshly made products.

Therefore, there is a need for having a method which allows the quick-freezing/freezing of said milk-derived products, such as for example the cream, or whey-derived products, such as for example the ricotta, or foodstuffs containing said milk- or whey-derived products, which is able to keep intact all the chemical-physical characteristics, organoleptic properties and palatability of a freshly made product.

The need to have a simple and cost-effective method for quick-freezing/freezing milk- or whey-derived products which would allow to extend their shelf life and keep the chemical-physical and organoleptic properties intact of said milk- or whey-derived products is even stronger when considering that many foodstuffs containing cream or ricotta as ingredient cannot be quick-frozen/frozen due to the described issues, impeding new, attractive commercial markets in faraway countries because of the high costs of air transportation typically required for fresh products. The same products, when quick-frozen/frozen, could be conveniently delivered by ship, thereby allowing a commercial exchange, presently infeasible. One example is represented by the burrata, which is well-known to containing cream.

Thus far, the burrata, once prepared with fresh cream, cannot undergo quick-freezing or freezing and subsequent thawing because of the above-cited reasons. The same applies for the burrata containing cream previously subjected to quick-freezing or freezing and subsequent thawing, prior to be used for preparing said burrata.

The Applicant met the above-cited needs by providing a method which allows to quick-freezing/freezing and, subsequently, thawing without inducing any damage or modification, milk derivatives such as cream or whey derivatives such as ricotta or mixtures thereof, or foodstuffs containing the same, all of which being particularly sensitive to such thermal treatments, due to their distinctive chemical-physical characteristics.

The method of the present invention is useful for preparing cream, ricotta and mixtures thereof, as well as foods containing the same, which keep intact their properties typical of freshly made products.

It is an object of the present invention a method for preparing a milk- or whey-derived product, or mixtures thereof, or a foodstuff containing the same, having the characteristics as defined in the appended claims.

It is an object of the present invention a milk- or whey-derived product, or mixtures thereof, or a foodstuff containing the same, obtained through said method, having the characteristics as defined in the appended claims.

It is an object of the present invention the use of said milk- or whey-derived product, or mixtures thereof obtained through said method, as ingredients for preparing a foodstuff or a dairy product containing the same, having the characteristics as defined in the appended claims.

Preferred embodiments of the present invention are described in the following detailed description by way of example and, therefore, without limiting the scope of the present invention.

Following to an intense and extended research and development activity, the Applicant surprisingly found that the addition of inulin or fructooligosaccharide (FOS) or mixtures thereof to a milk-derived product, such as for example cream, or to a whey derivative, such as for example ricotta, or mixtures thereof or to a foodstuff containing the same, during their preparation method, but prior to their quick-freezing/freezing, is able, in said derived products or mixtures thereof or in the foodstuffs containing the same as ingredient, to avoid the separation of the fat component (fatty phase) from the aqueous component (water phase) which form the fat-water emulsion of said milk- or whey-derived products, or mixtures thereof.

Therefore, it is an object of the present invention a method for preparing a milk- or whey-derived product, or mixtures thereof, or a foodstuff containing the same which involves, prior to the quick-freezing/freezing thereof, the use of a mixture comprising or, alternatively, consisting of inulin or fructooligosaccharide (FOS), or mixtures thereof, as disclosed below.

Within the context of the present invention the cream, the ricotta, or mixtures thereof and foodstuffs containing the same are prepared according to techniques and devices known to the skilled in the field.

Within the context of the present invention the thermal treatment of quick-freezing or freezing and subsequent thawing are performed by techniques and devices known to the skilled in the field.

In an embodiment, the present invention involves the use of said inulin having a degree of polymerization comprised from 11 to 60.

In another embodiment, the present invention involves the use of said fructooligosaccharide (FOS) having a degree of polymerization comprised from 2 to 10.

In another embodiment, the present invention involves the use of a mixture comprising or, alternatively, consisting of said inulin having a degree of polymerization comprised from 11 to 100, and said fructooligosaccharide (FOS) having a degree of polymerization comprised from 2 to 10.

Furthermore, it is an object of the present invention a method for preparing a foodstuff or dairy product such as for example the burrata, which contains, as ingredient, a milk- or whey-derived product, or mixtures thereof, said milk- or whey-derived product, or mixtures thereof being prepared by said method which involves, prior to quick-freezing/freezing said milk- or whey-derived product or mixtures thereof, the use of a mixture comprising or, alternatively, consisting of inulin or fructooligosaccharide (FOS) or mixtures thereof, as disclosed below.

It is another object of the present invention the use, as ingredient, of a milk or whey derivative, or mixtures thereof for preparing a foodstuff or dairy product, such as for example the burrata, wherein said milk or whey derivative has been previously prepared by said method which involves, prior to quick-freezing/freezing said milk- or whey-derived product or mixtures thereof, the use of a mixture comprising or, alternatively, consisting of inulin or fructooligosaccharide (FOS), or mixtures thereof, as disclosed below.

It is another object of the present invention the use of inulin having a degree of polymerization comprised from 11 to 60, or a fructooligosaccharide having a degree of polymerization (DP) comprised from 4 to 10, or mixtures thereof, for preparing a milk-derived product, preferably cream, a whey-derived product, preferably ricotta, or a foodstuff, preferably burrata.

In an embodiment of the present invention, inulin having a degree of polymerization comprised from 11 to 60, or a fructooligosaccharide having a degree of polymerization (DP) comprised from 4 to 10, or mixtures thereof are used.

The mixtures comprising or, alternatively, consisting of inulin and fructooligosaccharide may have a inulin:fructooligosaccharide weight ratio comprised, for example, from 1:50 to 50:1, preferably from 1:30 to 30:1, even more preferably from 1:20 to 20:1. In an embodiment, the inulin:fructooligosaccharide weight ratio is comprised from 1:10 to 10:1. In another embodiment, the inulin:fructooligosaccharide weight ratio is comprised from 1:5 to 5:1.

Inulin, fructooligosaccharide, or mixtures thereof are used in the present invention in an amount by weight comprised from 1 to 20%, relative to the weight of the milk- or whey-derived product, preferably in an amount by weight comprised from 5 to 15%, relative to the weight of the milk- or whey-derived product, even more preferably in an amount by weight comprised from 7 to 10%, advantageously 8%, relative to the weight of the milk- or whey-derived product.

Since they are sufficiently soluble even at room temperature, the inulin, or fructooligosaccharide, or mixtures thereof can be added to the cream or ricotta, or mixtures thereof at a temperature comprised from 4 to 95° C., during any step of preparation thereof, but in any case prior to the thermal treatment of quick-freezing/freezing.

The cream, or milk cream, is the product obtained by separating the fat from the other milk components. Inulin, fructooligosaccharide, or mixtures thereof are added to fat following to said separation step. As regards the ricotta, inulin, fructooligosaccharide, or mixtures thereof are added to the ricotta after its separation from whey.

For example, the cream or ricotta is prepared according to known techniques and devices and then inulin and/or fructooligosaccharide are added to the final product cream or ricotta, prior to the thermal treatment of quick-freezing/freezing.

As regards the burrata, two modalities are contemplate. The first one involves the preparation of the outer shell, according to known techniques and devices, and then the use of fresh cream added with inulin or fructooligosaccharide, or mixtures thereof. Thereafter, the burrata (shell+cream) is quick-frozen/frozen and, subsequently, thawed prior to be marketed for its consumption. The second modality involves the preparation of the outer shell, according to known techniques and devices and the preparation of a cream previously added with inulin, or fructooligosaccharide, or mixtures thereof, being quick-frozen/frozen and subsequently thawed. The thawed cream is used as filling of the burrata, which is stored at a temperature of 4° C. and marketed for its consumption.

It is another object of the present invention a method for preparing a milk- or whey-derived product which involves, prior to the quick-freezing/freezing thereof, the use of a mixture comprising or, alternatively, consisting of inulin and/or fructooligosaccharide; said mixture preferably further comprising one or more emulsifier additives listed among the additives approved by the European Community.

In a preferred embodiment, said additive is selected from the group comprising or, alternatively, consisting of mono- and/or di-glycerides of fatty acids (E471) and/or lactic esters of mono- and/or di-glycerides of fatty acids (E472b), being used at the dosage known to the skilled in the field.

Advantageously, the method of the present invention results very versatile, since it allows to quick-freezing or freezing any kind of milk-derived product, such as for example the cream, or whey derivative, such as for example the ricotta, or mixtures thereof regardless of the operating modes used in the preparation process of said derivatives for separating the fat or whey from the milk, the kind of thermal treatment being used for milk processing or the fat concentration being present, as set forth below.

The cream, or milk cream, is the product obtained by separating the fat from the other milk components. The cream, or milk cream separation can be obtained by subjecting the milk to spontaneous rising in a container at a temperature of 12-15° C. for 8-12 hours. The cream being obtained, referred to as “rising cream or sour cream” due to the production of lactic acid by lactic bacteria grown under these specific conditions, has a fat concentration of 20-25%. The separation can be also performed by centrifugation thus obtaining the so-called “centrifuged cream” having a fat amount ranging from 32 to 40%, or by whey centrifugation, by separating the little fat being present, for obtaining the “whey cream” having 44-48% of fat. The table below shows the differences in the composition of a cream obtained with the different modalities cited above:

CREAM COMPOSITION

| | RISING CREAM | CENTRIFUGED CREAM | WHEY CREAM |
|---|---|---|---|
| Fat | 20-25 | 32-40 | 44-48 |
| Water | 69-73 | 59-63 | 48-52 |
| Proteins | 2.5-2.7 | 0.7-08 | 0.3-0.5 |
| Lactose | 3.5-3.8 | 3.5-3.8 | 2.7-3.0 |
| Ashes | 0.5-0.6 | 0.5-0.6 | 0.1 |

Before to be marketed, the cream undergoes physical, mechanical and thermal treatments aimed to make it both stable for the intended technological purposes and safe as regards the health and hygiene aspect. In the mechanical treatment of homogenization the cream is passed, under high pressures, through a micrometer-sized passage. The pressure jump disrupts the fat globules resulting in fragments partially coated by the phospholipid membrane. The thermal treatment is aimed to the elimination of all the pathogenic germs and to the drastic lowering of the overall bacterial count. It is conducted with varying modalities depending on the intended use of the cream.

Depending on the fat matter titer, the cream can be divided in the following types: (i) coffee cream, ≧10% fat mass; (ii) cooking cream, ≧20% fat mass; (iii) whipping cream, ≧30% fat mass (usually 35-38%).

Triglycerides account for about 96% of milk lipids, along with small amounts of phospholipids, sterol esters, mostly represented by cholesterol, and fat-soluble vitamins. The fatty acid composition of milk triglycerides mainly consists of those saturated (about 70%), with an even number of carbon atoms.

The chemical characteristics affect some main physical parameters of milk fat matter, such as the extent of the melting point comprised between 22° C. and 36° C. and solidification point, comprised between 20° C. and 10° C. for suspended globules.

The Applicant found that the latter parameter (wide solidification range) plays a pivotal role in the mechanism underlying the separation of the fatty phase from the aqueous one during the quick-freezing/freezing of the cream. Solidification or, more precisely, crystallization of milk fat, is a two-step phenomenon: nucleation and growth of the crystal. The milk fat, due to the presence of more than 150 different kinds of fatty acids, has a heterogeneous nucleation starting at a temperature of about 20° C. and in some cases, depending on the lipid composition, a temperature of about 10° C. has to be reached for starting nucleation. From the seed crystals, the crystal growth is much slower than for pure triglycerides. Different crystals can be formed, characterized by specific lattices and melting points: α, β and β′ form crystals.

In order to better understand the meaning of the method being object of the present invention, it is useful to summarize the phenomena which may occur in the milk or cream emulsion.

Creaming: is the concentrating of the dispersed phase (fat) in the emulsion surface (e.g. cream formation). In the creaming the fat droplets are still surrounded by the emulsifier film of the MFGM membrane and under a proper stirring, the starting condition can be restored. Homogenization helps to avoid the creaming by reducing the globule diameter.

Flocculation: is the process of globule aggregation, which leads to the formation of aggregates linked through weak attractive forces. The phenomenon is promoted by the presence of cations in the aqueous medium, which neutralize the negative charge of the lipoprotein globular film not longer able to exerting electrostatic repulsion towards other globules. However, again the MFGM membrane surrounding the globules is intact and redispersion of the emulsion by stirring is still possible.

Coalescence: is the merging of fat agglomerates in greater droplets causing the separation of the lipid phase from the aqueous one. Coalescence is an irreversible phenomenon and the original emulsion cannot not be restored by simple stirring. Under critical conditions, such as those typical of quick-freezing or freezing, the lack of the repulsive effect exerted by the intact MFGM membrane allows the tiny fat globules to merge together in aggregates, distinct from the aqueous phase. The system collapses and the emulsion irreparably breaks.

The sequence of the events occurring under a temperature decrease during quick-freezing or freezing of a fresh pasteurized or UHT-sterilized cream and at any fat matter concentration, takes place through a series of steps. The phenomena are schematically described starting from a temperature of about 25° C.:

(a) At a temperature of about +25° C. the cream appears as a milky emulsion, with all the fat globules being separated and homogeneously distributed throughout the fluid volume.

(b) As the temperature decreases, the fat globules tend to rise and when the temperature reaches about +20° C. the first seed crystals start to forming. When the cream is for example of UHT type, the absence of the globule membrane MFGM allows the globules to start to aggregate (flocculation).

(c) At a temperature of about 10° C. the seed crystals of all the triglycerides composing the fat matter are formed; crystals of the first formed seeds started to grow up. When the cooling process is slow, stable crystals of β and β′ type are essentially formed.

(d) At a temperature of 7-8° C. the fat rising proceeds at the maximum rate.

(e) At temperatures just above zero degrees, the fat, merged in continuous lumpy aggregates, separated from the aqueous phase.

(f) When the temperature drops under zero degrees, the aqueous phase, containing nitrogen compounds, lactose and mineral salts, starts to freezing into crystals being much larger as slower the cooling rate is.

(g) When the overall cream is frozen, both fat and aqueous phase crystals can be found in the mass, separated from each other, with the fat matter being distributed more superficially than ice crystals.

(h) After thawing, the two phases result irreparably separated as previously described. Even a vigorous and continuous stirring is unable to restore the emulsion.

The Applicant tested a group of additives and hydrocolloids listed among the additives permitted by the European Community and mixtures thereof on: (i) a sample of fresh cream with 28% of fat matter, (ii) a sample of cream with 35% of fat matter, (iii) a sample of cream with 45% of fat matter. Particular attention has been paid to carrageenan (E407), which represents the most frequently used additive in many commercially available kinds of cream. The additive E407 is a polysaccharide having a highly variable molecular weight, generally comprised between 10.000 and 1.000.000. The Applicant found that, from a technological point of view, their addition to cream samples does not solve the issue of the emulsion instability resulting from the thermal treatment of quick-freezing or freezing. Indeed, it has been noted that their use is unable to avoid separation, in the milk-derived foodstuff, of the fatty component (fatty phase) from the aqueous component (water phase), which form the fat-water emulsion of said milk-derived foodstuff.

The same negative results were found by using a mixture of carrageenan and tara gum, at varying proportions and final concentrations in the cream from 0.1 to 2%. Likewise, the use of agar-agar (E406), locust bean gum (E410), guar gum (E412), tragacanth gum (E413), acacia gum or arabic gum (E414), xanthan gum (E415), gellan gum (E416), tara gum (E417) and mixtures thereof, as well as the addition of modified derivatives of cellulose (E460), methyl cellulose (E461), hydroxypropyl cellulose (E463), hydroxypropylmethyl cellulose (E464), ethylmethyl cellulose (E465), carboxymethyl cellulose (E466) and mixtures thereof never provided acceptable results.

After thawing the cream samples previously added with the above-cited additives and hydrocolloids, the aqueous phase separation is of lesser extent compared with that observed in the cream devoid of additives and hydrocolloids, but no reduction of the yellow lumpy fat aggregates formed after the thawing step can be noted. The gelling and thickening effect of the above-tested additives never resulted suitable for avoiding the fat matter separation. Accordingly, said additives and hydrocolloids, tested by the Applicant, are unable to provide a proper solution to the technical issue herein addressed.

Furthermore, as regards the above-tested thickening and/or gelling additives, it as to be said that they dissolve only at high temperatures, usually greater than 85° C. with previous maintenance of these conditions for some minutes. This aspect, beside the negative results obtained by using said additives and hydrocolloids, would lead, in any case, to a very complicated and difficult use thereof.

Neither changes in the freezing point by adding saline and/or sugar solutions, with consequent increase of the osmotic pressure, resulted in a positive effect, mostly leading to a worsening of the emulsion separation. The same negative results were obtained by changing the pH by lactic acid or sodium or calcium or magnesium bicarbonate. Any acidification, even with slight shifts from neutral pH (pH between 6.0 and 6.7, average value of the cream as such) always led to worsening effects, whereas moderate, even though unacceptable, improvements were found at slightly alkaline pH values.

Following to said research and development activity, as reported above, the Applicant selected inulin having a degree of polymerization comprised from 11 to 60, fructooligosaccharide (FOS) having a degree of polymerization comprised from 2 to 10 or mixtures thereof.

Native inulin, when subjected to enzymatic hydrolysis of the long chain with endoinulinase (EC 3.2.1.7) gives rise to short-chain fructans, also referred to as fructooligosaccharides (briefly, FOS) having a degree of polymerization comprised from 2 to 10 (average 4 DP). Therefore, the structural formula of FOS is equal to inulin, except for the number of fructose molecules, ranging from 1 to 9.

The presence of molecules with different average degree of polymerization DP, comprised between 11 and 60 for inulin and 2 and 10 for FOSs, allows the medium-short chain polymers to occupy the larger meshes of longer polymers, by forming a maze of networks with different sized meshes.

Basically, the overall space of the fluid volume is filled up with the different sized networks which intersect in a tangle of meshes suitable for entrapping the fat globules and rendering the emulsion viscous, before seed crystal formation. The intersection of polymer networks leads to a three-dimensional tangle in which the single fat globules are entrapped. The latter, devoid of the protective effect of the globule membrane secondary to homogenization and, thus, prone to merge together in aggregates of continuous fat matter, cannot freely move, as they are entrapped in the polymer networks of fructans (inulin, FOS, or mixtures thereof). When the temperature lowers, a condition that would favor the flocculation phenomenon and the subsequent coalescence, the network hinders the globule movements and, thus, their fusion in lumpy aggregates. Basically, fructans (inulin, FOS, or mixtures thereof), although with completely different mechanism, exert the same role of globule membrane MFGM in the cream, that is they virtually stabilize the two emulsion phases. The Applicant found that a further main action of fructans (inulin, FOS, or mixtures thereof), in particular inulin, in the cream system is due to their ability to bind water, a phenomenon which induces the formation of much smaller crystals than those of aqueous phase. Ultimately, the two mechanisms lead to the formation of much smaller fat and ice crystals, both homogeneously and widely dispersed throughout the fluid mass. The two phases, fatty and aqueous, never separate during the quick-freezing/freezing, even if the fat crystals are clearly distinct from those of aqueous phase. However, both have so small sizes to result evenly and homogeneously distributed, essentially mirroring the same spatial distribution of an emulsion at room temperature. The subsequent thawing step brings back the two emulsion phases to the same equilibrium existing before the quick-freezing/freezing step.

The Applicant experimentally found that the addition of inulin with different degree of polymerization (DP comprised between 11 and 60) at concentrations ranging from 1 to 20% by weight, preferably from 5 to 15% and even more preferably from 7 to 10%, in cream samples with 28%, 35% and 45% of fat matter, does not induce significant decreases in the cryoscopic point of cream, as shown by the following table which only refers, for the sake of simplicity, to the cream sample with 28% of fat matter.

| Sample | Cryoscopic point |
|---|---|
| Fresh cream with 28% fat | −0.664 |
| Fresh cream with 28% fat + 1% inulin (DP comprised between 11 and 60) | −1.268 |
| Fresh cream with 28% fat + 3% inulin (DP comprised between 11 and 60) | −1.561 |
| Fresh cream with 28% fat + 5% inulin (DP comprised between 11 and 60) | −1.681 |
| Fresh cream with 28% fat + 7% inulin (DP comprised between 11 and 60) | −1.693 |
| Fresh cream with 28% fat + 10% inulin (DP comprised between 11 and 60) | −1.703 |
| Fresh cream with 28% fat + 15% inulin (DP comprised between 11 and 60) | −1.716 |
| Fresh cream with 28% fat + 20% inulin (DP comprised between 11 and 60) | −1.734 |

Therefore, the slight change of the cream freezing point does not affect the positive effects of the two different mechanisms of action, which counteract the flocculation and subsequent coalescence of the emulsion. In other words, the formation of the tangle of polymer networks entrapping the fat globules and the bond formation between inulin or FOS and water, a phenomenon which leads, during the freezing, to the formation of more and smaller ice crystals, influence to such an extent the system emulsion that it is not affected by the slight decrease of the freezing point.

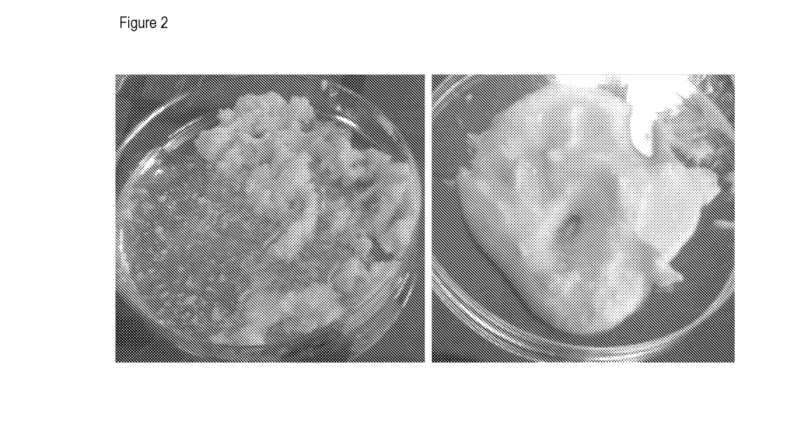

The pictures of FIG. 2 show: on the left, a fresh cream sample with 28% of fat matter, quick-frozen with the techniques and devices known to the skilled in the field, and then thawed as such (left picture) and, on the right, a fresh cream sample with 28% of fat matter prepared by adding an inulin amount of 4%, 5%, 6%, 7%, 8%, 10% and 12% by weight (for the sake of simplicity, only that with 7% by weight is shown) with different degree of polymerization (DP comprised between 11 and 60) and then frozen and, subsequently, thawed (right picture). In the picture of FIG. 2, on the right, relative to a cream added with 7% inulin with various degree of polymerization (DP comprised between 11 and 60) it can be observed:

(i) the absence of syneresis due to the emulsion collapse, with separation of the two phases,

(ii) the absence of visible graininess, also perceivable to the tasting,

(iii) the maintenance of a milky appearance, specific of the cream, and

(iv) a white color typical of the cream, without any yellowish shade.

The same results were obtained with cream samples with 35% and 45% of fat matter and an inulin amount of 4%, 5%, 6%, 8%, 10% and 12% by weight.

Advantageously, the positive effects deriving, in a method for preparing a milk-derived product, prior to the quick-freezing/freezing thereof, from the use of a mixture comprising or, alternatively, consisting of inulin, fructooligosaccharide (FOS) or mixtures thereof, concern not only the various kinds of milk-derived products, such as for example the cream or ricotta, but also all the foodstuffs containing for example cream or ricotta as ingredients of said foodstuffs. Indeed, a foodstuff can be made, for example, with cream previously quick-frozen/frozen and, subsequently, thawed before its use or, alternatively, said foodstuff can be made with fresh cream and only after the addition of fresh cream, said foodstuff can be quick-frozen/frozen. In both the cases, the cream, after thawing, still appears as a perfect white milky emulsion, with the distinctive milk flavor, without separation of the lipid phase from the aqueous one. By way of non-limiting example, the burrata, a fresh stretched-curd cheese from buffalo and/or caw milk, is mentioned. The burrata consists of an outer shell of stretched curds (60%) and an inner filling (40%) consisting of 50% cream and 50% strings (little rags) of stretched curds.

Advantageously, the method being object of the present invention allows to prepare a milk-derived product such as for example a burrata, which retains, once subjected to quick-freezing/freezing, all the typical characteristics of a fresh burrata, after thawing thereof. Therefore, the method of the present invention allows the transportation, at a storage temperature of less than −18° C. After its delivering, the classic cold chain for quick-frozen products would ensure a convenient use within 6 months from the date of production. In order to thawing the burrata, it would be sufficient to move it from the freezer (temperature of less than 18° C.) to the refrigerator (temperature +4° C.) During its cutting, the filling, based on cream and little rags of stretched curds, would result well amalgamated in the two phases composing the emulsion, without lump occurrence.

The method being object of the present invention also concerns the ricotta, a whey derivative also sensitive to quick-freezing/freezing, and for this reason it is considered non-quick-freezable/freezable as well as the cream. Indeed, there is evidence of both graininess increase of the protein phase and whey separation induced by the physical treatment during the transition from liquid to solid state, phenomena manifested during the thawing. Also with the ricotta, the addition of inulin having different degree of polymerization (DP comprised between 11 and 60), fructooligosaccharides with a DP comprised between 2 and 10, as well as mixtures of inulin and FOS avoids the phenomenon occurrence, allowing to obtain, after thawing, a ricotta with structural characteristics entirely overlapping to those prior to quick-freezing/freezing. The amount of inulin, or FOS, or mixtures thereof to be added to the ricotta prior to quick-freezing/freezing can vary from 1 to 10% by weight, preferably from 2 to 5% by weight, and even more preferably from 3 to 3.5% by weight. Fructans (inulin, FOS or mixtures thereof) should be preferably added to the ricotta during the homogenization-smoothing step following to the rising of the whey proteins and subsequent whey drainage, as described in the section below.

The ricotta is a dairy product not belonging to cheeses since it is not derived from milk, but from the whey of several mammals. Particularly valuable is the ricotta made from sheep. Technologically, the ricotta, as inferred by the Latin name re-coctus, is prepared through whey re-cooking under stirring at 80-90° C. with previous acidification with citric, tartaric and lactic acid, a condition that eases the coagulation of whey proteins, essentially consisting of albumin and globulins. When the first whey protein flakes start to rise to the surface of the vessel, the stirring is stopped, whereby promoting the rising of all the whey proteins. A process which ensures a yield increase, and a more sweet ricotta, involves the replacement of acids with specific salts, usually of magnesium, being able to bring about, at high temperatures, the whey protein denaturation and their rising to the surface. This step is followed by the extraction of the protein mass, which is left for draining in perforated containers. After purging, the industrially produced ricotta undergoes a homogenization process, also called smoothing for the effects induced on the structural characteristics of the product. Homogenization is performed under varying pressures depending on the desired smoothing degree, in a funnel-shaped container: the ricotta is forced to pass through a nozzle placed at the bottom of the funnel truncated cone with smaller diameter (stem of the funnel) and pumped back in the upper cone with greater diameter. The closed circuit and loop process is stopped as the desired structure is achieved, followed by the packaging step.

As regards the ricotta, the mechanisms of action of the method being object of the present invention are the same as described for the cream: (a) formation of a three-dimensional tangle of polymer networks and (b) bond formation among inulin and water molecules of the system. The first mechanism strengthens the structure of the colloidal suspension consisting of whey proteins, avoiding the partial collapse due to the quick-freezing/freezing step. The second mechanism causes the size reduction of the aqueous phase crystals during the freezing. The combination of the two phenomena confers compactness to the dispersed phase of the colloidal suspension, consisting of whey protein aggregates, avoiding the separation (even partial) of the whey, which represents the aqueous phase of the system.

If the ricotta is made with whey from whole milk, or enriched with further whole milk and/or cream, the polymer network of inulin with different degree of polymerization also acts entrapping the fat globules, thus avoiding flocculation and coalescence of the fat matter, as described for the cream.

In some cases, beside the addition of inulin or FOS, mainly if the ricotta is too dry due to a poor whey amount, it is advantageous also to adding, prior to quick-freezing/freezing, a suitable amount of pasteurized milk, preferably whole milk, which confers a greater softness to the product. Beside the pasteurized milk, a fresh pasteurized milk, high quality fresh pasteurized milk, microfiltered milk, long-life sterilized milk and UHT milk can be used. The suitable milk amount to be added along with fructans (inulin, FOS or mixtures thereof) for obtaining a softer and creamed ricotta can vary from 1 to 20%, preferably from 5 to 15% and even more preferably from 8 to 12%. Also the milk can be added to the ricotta, along with fructans (inulin, FOS or mixtures thereof), preferably during the homogenization-smoothing step.

1. A method for quick-freezing or freezing a milk-derived product, or a whey-derived product or mixtures thereof, or a foodstuff containing said milk-derived product, or said whey-derived product, or mixtures thereof; said method comprising the addition, during the preparation process of said milk- or whey-derived product, or mixtures thereof or during the preparation process of said foodstuff containing said milk or whey derivatives, or mixtures thereof, of a mixture comprising or, alternatively, consisting of inulin, fructooligosaccharide or mixtures thereof, said addition being performed prior to the thermal treatment of quick-freezing or freezing.

2. The method according to claim 1, wherein said milk derivative is cream, said whey derivative is ricotta and said foodstuff containing said milk derivative is burrata; all the above, once quick-frozen/frozen, being thawed and stored at a temperature of 4° C.

3. The method according to claim 1, wherein said inulin, fructooligosaccharide or mixtures thereof are added to said milk derivative, preferably cream, which is a product being obtained by separating the fat from the other milk components, only after that the milk fat is separated from the other milk components.

4. The method according to claim 1, wherein said inulin, fructooligosaccharide or mixtures thereof are added to the ricotta preferably during the homogenization and smoothing step.

5. The method according to claim 1,
wherein:
(i) said inulin has an average degree of polymerization comprised from 11 to 60;
(ii) said fructooligosaccharide has an average degree of polymerization comprised from 2 to 10; or
(iii) mixtures of said inulin and said fructooligosaccharide.

6. The method according to claim 1, wherein said mixture comprising or, alternatively, consisting of inulin, fructooligosaccharide or mixtures thereof has an inulin: fructooligosaccharide weight ratio comprised from 1:50 to 50:1, preferably from 1:30 to 30:1, even more preferably from 1:20 to 20:1.

7. The method according to claim 1,
wherein said mixture comprising or, alternatively, consisting of inulin, fructooligosaccharide or mixtures thereof is used:
(i) when the milk derivative is cream, in an amount by weight comprised from 1 to 20%, relative to the weight of the milk-derived product; preferably in an amount by weight comprised from 5 to 15%, relative to the weight of the milk-derived product; even more preferably in an amount by weight comprised from 7 to 10%, relative to the weight of the milk-derived product;
(ii) when the whey derivative is ricotta, in an amount by weight comprised from 1 to 10%, relative to the weight of the whey-derived product; preferably in an amount by weight comprised from 2 to 5%, relative to the weight of the whey-derived product; even more preferably in an amount by weight comprised from 3 to 3.5%, relative to the weight of the whey-derived product.

8. A milk- or whey-derived product, or mixtures thereof, or a foodstuff containing said milk or whey derivatives, or mixtures thereof, wherein said product can be obtained by the method according to claim 1.

9. Use of a milk- or whey-derived product, or mixtures thereof according to claim 8 as ingredient for preparing a foodstuff, preferably said milk-derived product is cream and said foodstuff is burrata.

10. Use of inulin having a degree of polymerization comprised from 11 to 60, or a fructooligosaccharide having a degree of polymerization (DP) comprised from 4 to 10, or mixtures thereof, for preparing a milk-derived product, preferably cream, a whey-derived product, preferably ricotta, or a foodstuff, preferably burrata.
